(19) United States
(12) Patent Application Publication
(10) Pub. No.: US 2017/0223935 A1
(43) Pub. Date: Aug. 10, 2017

(54) CONTAINER FOR AQUATIC PLANTS

(71) Applicant: Wolfgang BEHRENS, Gross Ippener (DE)

(72) Inventor: Wolfgang BEHRENS, Gross Ippener (DE)

(21) Appl. No.: 15/017,809

(22) Filed: Feb. 8, 2016

(51) Int. Cl. A01K 63/00; B65D 81/18; A01G 9/26; A01G 31/02; A01G 31/00; A01G 9/24; B65D 81/38; B65D 85/52

(52) U.S. Cl. CPC A01K 63/003; B65D 81/3813; B65D 81/18; B65D 85/52; A01G 31/02; A01G 31/001; A01G 9/243; A01G 9/26; A01G 2031/005

(57) ABSTRACT

Container for aquatic plants, which can be filled with water, the side walls and bottom of which comprise an outer wall and a bottom wall, respectively, in each instance, followed, toward the interior of the container, by an intermediate layer that consists of an insulating material. On the inside of the container, the insulating material is completely covered with a water-tight plastic film, in the manner of a tub, or by a water-tight basin composed of transparent glass. On the bottom of the tub or of the basin and/or in a plant pot situated in the container, there is a plant culture medium that makes growth of aquatic plants possible, and preferably winter-hardy and/or non-winter-hardy aquatic plants are disposed in the container, which is filled with water.

The invention relates to a container for aquatic plants, which can be filled with water, in accordance with the preamble of claim 1 and the preamble of claim 26.

It is known that many different plants and flowers can grow in a garden. For the present invention, aquatic plants, above all, and water lilies, in particular, are of importance, specifically taking into consideration the climate conditions in Central Europe. For these climate conditions, not only the warm season but also cold periods with freezing weather must be taken into consideration.

It has been usual for a longer time to provide aquatic plants when designing parks and home gardens. Water lilies, above all, enjoy great popularity due to their attractiveness and variety of types. Water lilies are generally kept in natural or artificial ponds and lakes. Starting from a certain depth and size of a pond, overwintering of winter-hardy water lilies is actually possible, without them freezing under the climate conditions in Central Europe. Instead, in large and deep ponds the winter-hardy water lilies are sufficiently protected against rapid cooling in winter, toward the sides and downward toward the ground, by the adjacent soil region.

Because home gardens are generally limited in size and large areas are not available, only smaller and relatively flat ponds are possible for keeping water lilies here, in which the water lilies—even winter-hardy water lilies—cannot overwinter. This is because the small ponds, depending on the course of the weather and lasting periods of freezing, can actually freeze completely. The water lilies are therefore lost and must be newly purchased and planted in the spring. Today, keeping water lilies and other aquatic plants year-round in one's own garden, in ponds having a low water depth, is not possible, and this is disadvantageous.

A further disadvantage consists in that when building a garden pond to keep water lilies at a specific location, the design of the garden is practically established permanently. When a pond is completed, it is maintained at the specific location and cannot be moved to a different site, like a movable object, if a re-design of the garden is desired. Instead, in the case of a re-design, it is necessary to build a new pond and to fill the old pond, if necessary, in order to give the water lilies a new location in the garden.

The invention is based on the task of avoiding the disadvantages described above, and of creating a container that allows year-round keeping of aquatic plants, particularly of winter-hardy water lilies, at any desired locations in a garden, under climate conditions in Central Europe.

The solution of this task is accomplished, in a first embodiment of the invention, in the case of the container mentioned in the preamble of claim 1, by means of the characterizing parts of claim 1.

In the invention, the side walls of the container comprise an outer wall, in each instance, which is followed, toward the interior of the container, by an intermediate wall formed by an insulating material, in each instance. The bottom of the container has an outer bottom wall, which is followed, toward the interior of the container, by a bottom intermediate wall, which is also formed by an insulating material. Finally, in the interior of the container, a water-tight inner layer that completely covers the said intermediate walls is provided on the intermediate walls of the side wall as well as on the bottom intermediate wall. In the region of the bottom of the container, a plant culture medium that makes the growth of aquatic plants possible is provided on the inner layer, and/or a plant pot provided with a plant culture medium is situated in the container, and winter-hardy and/or non-winter-hardy aquatic plants are disposed in the container, which is filled with water.

In the invention having the multi-layer structure of the container, the intermediate walls form a heat-insulating layer on the sides and at the bottom of the container. The heat insulation achieved in this manner advantageously prevents the container from freezing completely in winter, and results in lesser temperature variations in the summer, without the need to design the container to be particularly large and deep in order to prevent it from freezing completely. In the container according to the invention, the heat insulation practically replaces the soil region in large and deep ponds, and takes on the function of this region, that of counteracting complete freezing.

The container according to the invention is a movable object and can thereby be moved to other regions of the garden, in uncomplicated manner, if a re-design of the garden is desired.

While known ponds are laid out level with the ground, at the level of the soil, it is possible, when using containers according to the invention, to bring the plants to a desired height, similar to a raised bed. This makes care of the plants clearly more convenient, and entirely different optical viewing possibilities of the water lilies also occur.

In advantageous manner, the container according to the invention can be structured with different heights/depths, and the container can thereby be adapted to the desires of the customer and also to the requirements of the plant depth, in terms of its height. The only condition is that a minimum volume of the container or of the water used is maintained, as a function of the thickness of the heat insulation, so that during the winter, the water in the container does not freeze down into the region of the plant parts that are capable of overwintering.

In advantageous manner, it is possible, by means of using the container according to the invention, to overwinter water lilies in the container even during extended periods of freezing under the climate conditions in Central Europe, without the water lilies suffering any damage. Complicated and costly replanting or complicated overwintering of the water lilies in particularly protected spaces during the winter is eliminated. Instead, the water lilies sprout again in the spring, without being disturbed, and excellently rooted in their plant culture medium or substrate. Because of the heat insulation provided in the invention, the container can be significantly smaller in terms of height, width, and volume than normal plant containers without heat insulation.

In a practical embodiment of the invention, the inner layer is formed by a plastic film, which is particularly suitable as a water-tight layer and thereby prevents undesirable outflow of the water situated in the container.

In place of a plastic film, a complete tub or a complete basin composed of plastic or Plexiglas/glass can also be used, in advantageous manner.

In the invention, it is advantageous if the insulating material consists of hydrophobic rock wool or polystyrene. These substances form a water-repelling insulating material and demonstrate excellent insulating properties.

It is practical if the outer walls and the bottom wall of the container are formed by wood, plastic, or noble metal. These materials are stable, in order to withstand the pressure exerted by the water in the container.

In a further advantageous embodiment of the invention, aquatic animals such as fish, amphibians, reptiles, snails or mollusks can also be situated in the water of the container. For the observer, the interior of the container, in combination with the water lilies, thereby represents an interesting biotope.

Another practical embodiment of the invention provides that the container is provided with a protective grid on its top, open side, through which the aquatic plants can grow.

If there are also fish in the container along with the water lilies, the protective grid prevents fish that tend to jump from being able to jump out of the container.

In a practical embodiment of the invention, the container is provided with an overflow to allow excess water to flow off. If the water level in the container rises as the result of rain, the excess water can flow off through the overflow.

In a particularly advantageous embodiment of the invention, there is a bottom heating device on the bottom of the container.

The water in the container can be heated by this bottom heating device, thereby supporting the insulation of the container in cold temperatures. The bottom heating device can also be put into operation at summer temperatures, thereby advantageously making the use of tropical plants in the container possible.

In practical manner, the bottom heating device is formed by means of heating coils laid on the bottom of the container, through which a warm fluid flows. In order to hold the heating coils on the bottom, a heat-conductive granulate or a grid can be laid onto the heating coils to weigh them down.

A nylon loop mat laminated to a nonwoven fabric on both sides can be laid onto this grid, over its full area. This promotes uniform heat distribution of the heating coils that lie underneath, and prevents direct heat damage caused by the clearly warmer heat coils; furthermore, they distribute the pressure of the plant pots or of the plant culture medium above the heating coils; the thickness of the nylon loop mat can lie between 5 and 50 mm.

Use of the heating elements is not restricted to the bottom. Instead, the heating elements can also be used at different levels. A wall heating device is also possible.

In advantageous manner, the bottom heating device can be operated with a heat pump or also with solar energy. It can also be practical to form the bottom heating device by means of a heat cable operated with electrical current, which cable can be connected with an electrical outlet. In advantageous manner, the bottom heating device can also be formed by means of heating rods operated with electrical current, which rods can be connected with an electrical outlet.

In practical manner, the heating rods can also be used in the upper region of the container. This is technically practical, because some heating rods are not allowed to be immersed completely and/or by means of regulation of a thermostat situated on them is not guaranteed if the thermostat is not directly accessible at the water surface.

Another practical embodiment of the invention provides that the container is configured without an outer wall and intermediate wall in the region of at least one side, and that the water-tight inner layer is formed by a basin formed from transparent material. At least in the region of the side configured without an outer wall and an intermediate wall, the basin consists of transparent material, which forms a front pane in the said region.

By means of these measures, it is possible to configure one side of the container to be transparent, so that the observer has a view into the interior of the container not only from above, but also from the side, and can look at the water lilies and other living beings in the container not only from the surface, but also as a whole, in the cross-section of the container.

In practical manner, glass or also Plexiglas having sufficient stability can be used as a transparent material for the basin.

In a practical embodiment of the invention, only the front pane is formed from transparent material and is glued to the remaining part of the container in water-tight manner.

As desired, the container can be configured not only to be rectangular but also in the manner of a barrel having a round cross-section. In this regard, it is provided, in a practical embodiment of the invention, that the round container has a partial region that is configured without an outer wall and intermediate wall, wherein the water-tight inner layer is formed by a round basin composed of transparent material.

In advantageous manner, it is provided, in this regard, that only the partial region consists of transparent material, and that the partial region, in the form of a front pane, is glued to the remaining part of the round basin in water-tight manner.

In a practical embodiment of the invention, the outer walls can disposed in a metal frame. Sufficient stability of the outer walls, which are exposed to the pressure of the water situated in the container, is guaranteed by this metal frame. It is advantageous if multiple metal frames disposed next to one another are provided for a side wall. This variant is practical if particularly large side walls are present.

In a second embodiment of the invention, the solution of the task on which the invention is based is accomplished, in the case of the container mentioned in the preamble of claim 26, by means of the characteristics of the characterizing part of claim 26.

In this regard, the side walls and the bottom of the container are configured to be hollow and form a cavity. A plant culture medium that makes the growth of aquatic plants possible is provided on the bottom of the container, and winter-hardy and/or non-winter-hardy aquatic plants are disposed in the container, which is filled with water.

In this embodiment of the invention, the cavity brings about heat insulation, thereby making it possible to counteract complete freezing of the container or of the water situated in it in the winter, at temperatures below freezing, so that it is possible to keep aquatic plants, particularly water lilies, year-round. On the other hand, the cavity brings about only slight temperature variations of the water during the summer.

In an advantageous embodiment of the invention, the cavity of the container is filled with an insulating material. By means of this measure, the heat-insulating property of the cavity is increased in advantageous manner. In this regard, it is practical to use hydrophobic rock wool or polystyrene as the insulating material.

In practical manner, the winter-hardy aquatic plants are formed by winter-hardy water lilies.

Another practical further development of the invention provides that there is a vacuum in the cavity. In this way, too, the heat-insulating property of the cavity is increased. In advantageous manner, it is also possible, in many cases, that the cavity is filled with air.

According to another advantageous further development of the invention, the inner sides of the side walls and the bottom are covered with a water-tight film. In this way, it is guaranteed that no water can penetrate into the cavity of the container.

An advantageous further development of the invention consists in that the inner sides of the side walls and the bottom are covered by a water-tight, stable tub that is provided as an insert.

It is practical if aquatic animals such as fish, amphibians, reptiles, snails or mollusks are situated in the water of the container.

In an advantageous embodiment of the invention, the container is provided with a protective grid on its open, top side, through which the aquatic plants can grow. If there are fish in the container, the protective grid prevents fish from jumping out of the container.

It is practical if the container is provided with an overflow for excess water to close off. In the case of heavy rain, the overflow ensures orderly flowing off of the excess water.

It is particularly advantageous if a blister film is laid onto the water surface of the water situated in the basin in the fall and/or in the winter, covering the entire surface. This blister film floats directly on the water. It is known that blister films comprise air inclusions, and the blister film itself floats on the water surface by means of these air inclusions.

It is practical to provide multiple sections of a blister film next to one another, with the sections overlapping slightly at the ends. Any rain water or snow that might occur and collect on the blister film can run off into the basin, so that the blister film is prevented from sinking.

If necessary, additional wind suction protection can take place by means of laying down weights (wooden slats, etc.). A blister film from the gardening sector, having the following properties, has proven to be practical: “for energy savings in gardening, as well as for winter coverage; 3-layer, transparent, UV-stable, blister diameter 3 cm, weight per surface area 138 g/m², thickness 150 μm.”

Effective winter heat protection is achieved with the blister film, i.e. by means of covering the water surface with the blister film.

Further practical embodiments of the invention are indicated in the dependent claims.

In the following, the invention will be explained in greater detail using the exemplary embodiments shown in the drawing. The figures show:

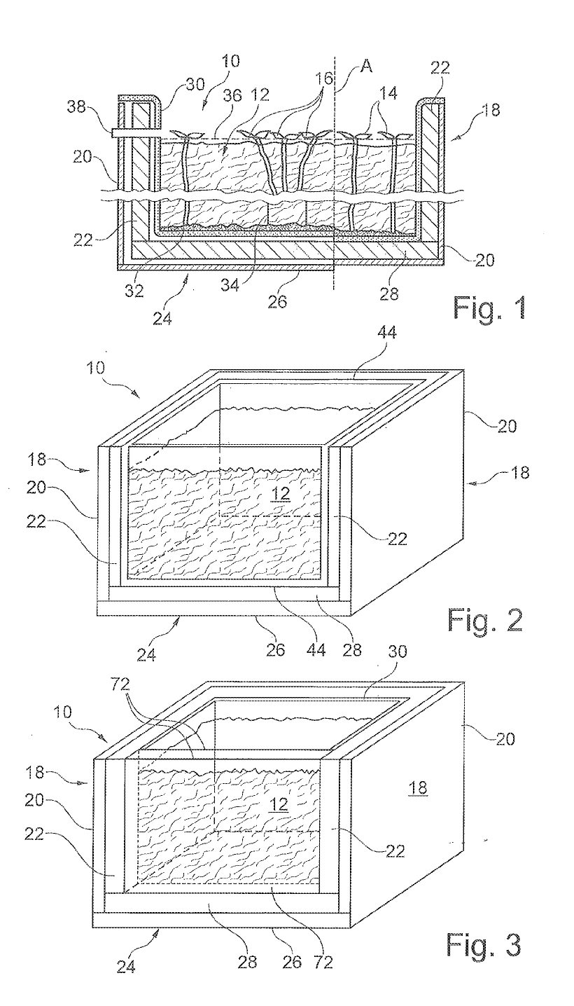

FIG. 1 A schematic cross-sectional view of a first exemplary embodiment of the first embodiment of the invention,

FIG. 2 a schematic perspective representation of a second exemplary embodiment of the invention according to the first embodiment,

FIG. 3 a schematic perspective representation of a further exemplary embodiment of the invention according to the first embodiment, modeled after FIG. 2,

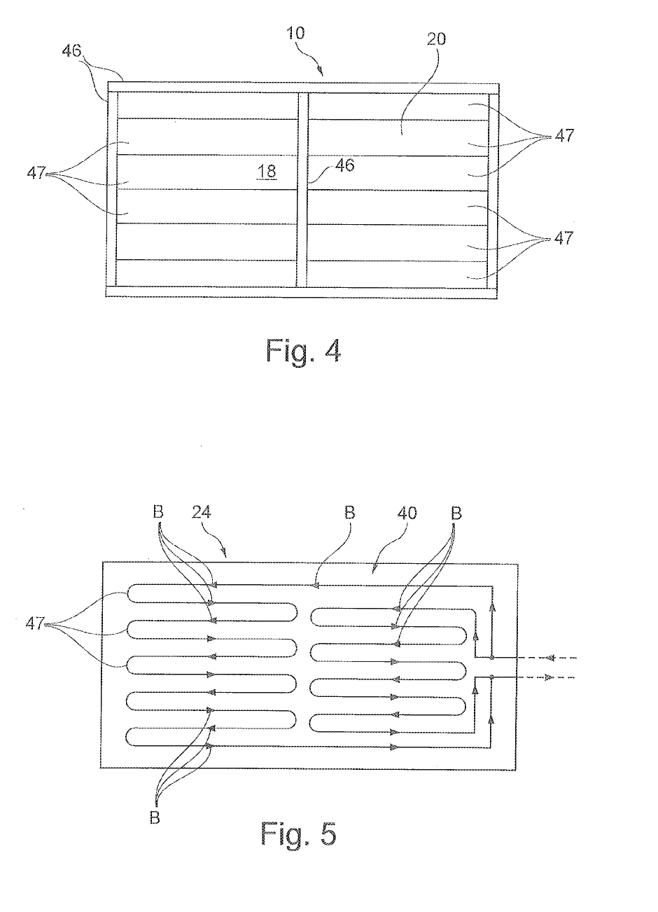

FIG. 4 a side view of a container according to the invention, according to an exemplary embodiment of the first embodiment of the invention,

FIG. 5 a top view of a bottom heating device according to the first embodiment of the invention,

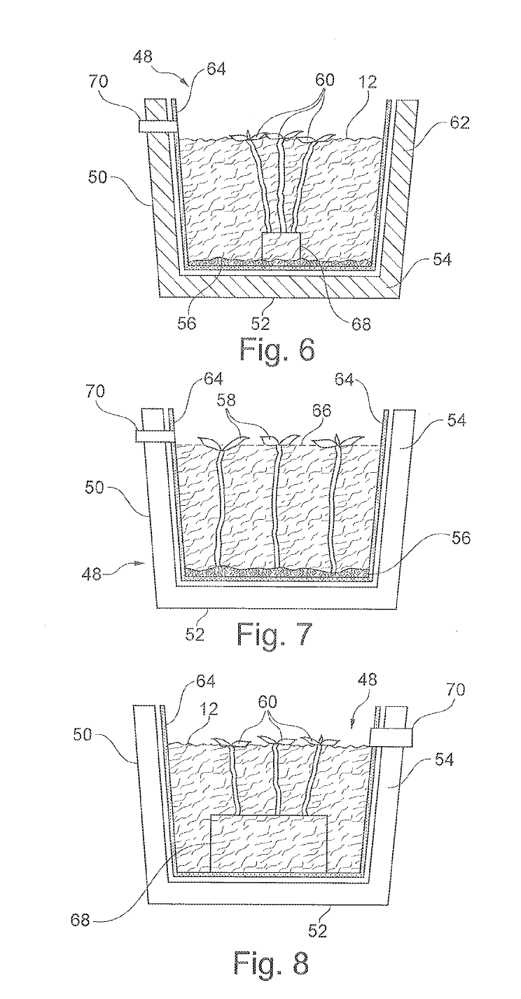

FIG. 6 a schematic cross-sectional view according to a first exemplary embodiment of the second embodiment of the invention,

FIG. 7 a schematic cross-sectional view according to a second exemplary embodiment of the second embodiment of the invention, and

FIG. 8 a schematic cross-sectional view according to a further exemplary embodiment of the second embodiment of the invention, modeled after FIG. 7.

In FIG. 1, a container 10 according to an exemplary embodiment of the first embodiment of the invention is shown. The rectangular container 10, filled with water 12, is formed by four side walls 18 as well as by a bottom 24.

The side walls are structured in multiple layers and consist of an outer wall 20, an intermediate wall 22, which follows the outer wall toward the inside, and an inner layer 30 composed of a plastic film, which follows the intermediate wall toward the inside. The intermediate walls 22 are formed by an insulating material, for example hydrophobic rock wool or polystyrene. Wood, plastic or noble metal can be used for the outer walls 20 and the bottom wall 26.

The bottom 24 is formed by an outer, lower bottom wall 26, which is followed by a bottom intermediate wall 28, which is formed by an insulating material, corresponding to the intermediate walls 22. The inner layer 30 composed of plastic film, which has already been mentioned, follows the bottom intermediate wall (28), which layer covers not only the bottom intermediate wall 28 but also the intermediate walls 22.

To clarify the multi-layer structure of the container 10 or of the side walls 18 and the bottom 24, the individual components are shown at a distance from one another on the left, next to the perpendicular broken line A. On the right side of the broken line A, the individual components lie directly against one another.

At the bottom of the container 10, there is a plant culture medium 32, in which the roots of winter-hardy water lilies 14 or other aquatic plants can extend. Furthermore, a plant pot 34 is shown on the plant culture medium 32, in which non-winter-hardy water lilies 16, for example, grow. The use of a plant pot offers the possibility of being able to use water lilies or also other aquatic plants having low growth heights, and of being able to adapt the height difference without great effort. In contrast, water lilies whose growth height correspond to the height of the water 12 in the container 10 can grow directly in the plant culture medium 32, without a plant container 34.

In the region of the surface of the water 10, there is a protective grid 36 in the container 10. The grid structure of the protective grid 36 is composed in such a manner that the water lilies 14 and 16 can grow through the protective grid 36. In the event that fish are released in the water 10, the protective grid 36 prevents fish that tend to jump from jumping out of the water 10. In addition, the protective grid 36 also prevents small children from being able to fall into the container 10.

The container 10 is equipped with an overflow 38 on at least one side. In the event of heavy rainfall, the rising water 10 can run off through this overflow 38.

In FIG. 2, a second exemplary embodiment of the first embodiment of the invention is shown, wherein the inner layer 30 described in FIG. 1 is formed by a basin 44 consisting of transparent material, in which basin the water 12 is situated. For reasons of clarity, no water lilies and no plant culture medium are shown in FIG. 2.

The container 10 comprises not only the basin 44 but also the bottom 24 as well as three side walls 18, which by three outer walls 20 and intermediate walls 22 composed of insulating material that follow them. The bottom 24 is formed by the outer bottom wall 26 and the bottom intermediate wall 28 composed of insulating material that follows it.

Aside from the use of the basin 44, the special feature of the container 10 consists in that no side wall is provided at the front side. At this location, the side of the basin 44 that is in question is exposed, and because the basin 44 consists of a transparent viewing element composed of glass or Plexiglas, the observer can look into the container 10 below the surface of the water 12 and here can view water lilies and other aquatic plants, not shown, from a completely new viewing angle.

Because of the missing outer wall 20 and intermediate wall 22, the open side of the container 10 is practically unprotected at cold temperatures. However, the possibility exists of protecting and covering the open side during the winter, by means of an individual element of a side wall 18 having an outer wall 20 and intermediate wall 22. In the spring, the corresponding, releasably attached element of the side wall 18 can then be removed again.

Also in the case of the further exemplary embodiment of the invention shown in FIG. 3, the front side of the container 10 is configured to be transparent, so that the observer can look into the interior of the container 10.

However, in contrast to FIG. 2, a basin 44 that is transparent as a whole is not provided. Instead, only the front side of the container 10, in the form of a front pane 72, is transparent (composed of glass or Plexiglas). The remaining inner surfaces of the container 10 are covered by the water-tight plastic film 30 that has already been mentioned in FIG. 1. The front pane 72 is firmly glued to the container 10, in water-tight manner, in the region of the front side of the container 10. In total, the plastic film 30, together with the front pane 72, forms an insert in the form of a water-tight tub or a water-tight basin.

FIG. 4 shows a third exemplary embodiment according to the first embodiment of the invention. A side wall 18 of a container 10 is shown, wherein the outer wall 20 is formed by slats 47 disposed perpendicularly one on top of the other. These slats 47 are held in grooves, not shown, of a metal frame 46. Sufficient stability is imparted to the side walls 18 of the container 10 by the metal frames 46, in order to withstand the pressure of the water 12 situated in the container 10.

In FIG. 5, a variant of the first embodiment of the invention is shown, in which a bottom heating device 40 is disposed on the bottom 24. In known manner, the bottom heating device 40 is formed by heating coils 42, which are structured in the manner of a pipe and through which heated fluid flows in the direction of the arrow tips B. The bottom heating device 40 can be operated in known manner, by means of a heat pump or using solar energy. In addition, operation with conventional electrical current is also possible.

As has already been mentioned, a grid, not shown here, can be laid onto the heating coils 42 to weigh them down, and a nylon loop mat, laminated to a nonwoven fabric on both sides, also not shown, can be laid onto this grid, over its full area. This nylon loop mat promotes uniform heat distribution of the heating coils that lie underneath it, and prevents direct heat damage caused by the clearly warmer heating coils. The thickness of the nylon loop mats can amount to between 5 and 50 mm.

The water heats up in the region of the bottom, by means of the bottom heating device 40, and the warm water subsequently rises upward. As a result, the entire water 12 in the container 10 warms up. By means of the bottom heating device, it is possible to use tropical plants, as well, in the summer, along with the water lilies, if the temperature of the water 12 is correspondingly set by means of the bottom heating device 40.

The drawing according to FIG. 6 shows a first exemplary embodiment of the second embodiment of the invention in a schematic cross-sectional view. Here, the side walls 50 and the bottom 52 of the container 48 are configured to be hollow, so that they produce a cavity 54. On the bottom 52 of the container 48, there is a plant culture medium 56 that makes the growth of aquatic plants possible. In the exemplary embodiment shown, a plant pot 68 is provided, in which non-winter-hardy water lilies 60 grow, for example.

The cavity 54 is filled with an insulating material 62. The bottom 52 and the side walls 50 are covered by a water-tight film 64 in the interior of the container 48, which film forms a tub. Corresponding to the first embodiment of the invention according to FIG. 1, the container 48 is provided with an overflow 70.

In the exemplary embodiment of the second embodiment of the invention shown in FIG. 7, there is a vacuum in the cavity 54, thereby also achieving a heat-insulating property of the side walls 54 and of the bottom 52. The roots of aquatic plants, for example of winter-hardy water lilies 58, extend in the plant culture medium 56. As was already the case in the embodiment of the invention according to FIG. 1, a protective grid 66 is provided here, as well.

Modeled after FIG. 7, FIG. 8 shows a further embodiment of the invention, wherein no separate plant culture medium is provided on the bottom of the container 48 or on the film 64 situated there. Instead, the plant pot 68, which contains a plant culture medium and thereby makes growth of water lilies 60 possible, is situated in the container 48.

### REFERENCE SYMBOL LIST

10 container
12 water
14 winter-hardy aquatic plants/water lilies
16 non-winter-hardy aquatic plants/water lilies
18 side walls
20 outer wall
22 intermediate walls/insulating material
24 bottom
26 outer bottom wall
28 bottom intermediate wall/insulating material
30 inner layer/plastic film
32 plant culture medium
34 plant pot
36 protective grid
38 overflow
40 bottom heating device
42 heating coils
44 basin
46 metal frame
47 boards
48 container
50 side walls
52 bottom
54 cavity
56 plant culture medium
58 winter-hardy aquatic plants/water lilies
60 non-winter-hardy aquatic plants/water lilies
62 insulating material
64 film
66 protective grid
68 plant pot
70 overflow
72 front pane
A broken line
B arrow tips

1: Container (10) for aquatic plants (14; 16), which can be filled with water (12), having side walls (18) and a bottom (24), wherein the side walls (18) comprise an outer wall (20), in each instance, which is followed, toward the interior of the container (10), by an intermediate wall (22) formed by an insulating material, that the bottom (24) has an outer bottom wall (26), which is followed by a bottom intermediate wall (28), which is formed by an insulating material, and wherein a water-tight inner layer (30) that completely covers the intermediate walls (22; 28) is provided on the intermediate walls (22) of the side walls (18), on their sides facing the interior of the container (10), as well as on the bottom intermediate wall (28), on its side facing the interior of the container (10), and wherein a plant culture medium that makes the growth of aquatic plants (14; 16) possible is provided on the inner layer of the bottom (24) and/or in a plant pot (34) situated in the container (10), and wherein winter-hardy (14) and/or non-winter-hardy aquatic plants (16) are disposed in the container (10), which is filled with water (12).

2: Container according to claim 1, wherein the inner layer (30) is formed by a plastic film.

3: Container according to claim 1, wherein the winter-hardy aquatic plants (14) are formed by winter-hardy water lilies.

4: Container according to claim 1, wherein the insulating material (22) comprises hydrophobic rock wool or polystyrene.

5: Container according to claim 1, wherein the outer walls (20) and the bottom wall (26) are formed by wood, plastic or noble metal.

6: Container according to claim 1, wherein aquatic animals such as fish, amphibians, reptiles, snails or mollusks are situated in the water of the container.

7: Container according to claim 1, wherein the container (10) is provided with a protective grid (36) on its top, open side, through which the aquatic plants (14; 16) can grow.

8: Container according to claim 1, wherein the container (10) is provided with an overflow (38) to allow excess water (12) to flow off.

9: Container according to claim 1, wherein a bottom heating device (40) is disposed on the bottom (24) of the container (10).

10: Container according to claim 9, wherein the bottom heating device (40) is formed by heating coils (42) laid on the bottom (24) of the container (10) or disposed above the bottom (24), through which coils a warm fluid flows.

11: Container according to claim 10, wherein a grid is laid onto the heating coils to weigh them down.

12: Container according to claim 11, wherein a nylon loop mat laminated to a nonwoven fabric on both sides is disposed on the grid, over its full area.

13: Container according to claim 9, wherein the bottom heating device (40) is operated with a heat pump.

14: Container according to claim 9, wherein the bottom heating device (40) is operated with solar energy.

15: Container according to claim 9, wherein the bottom heating device is formed by a heat cable operated with electrical current, which cable can be connected to an electrical outlet.

16: Container according to claim 9, wherein the bottom heating device is formed by heating rods operated with electrical current, which rods can be connected to an electrical outlet.

17: Container according to claim 1, wherein the container (10) is configured without an outer wall (20) and intermediate wall (22) in the region of at least one side, and wherein the water-tight inner layer (30) is formed by a water-tight basin (44), which comprises, at least in the region of the side configured without an outer wall (20) and an intermediate wall (22), transparent material, which forms a front pane in the said region.

18: Container according to claim 17, wherein the entire basin (44) comprises glass.

19: Container according to claim 17, wherein the entire basin (44) comprises Plexiglas.

20: Container according to claim 17, wherein only the front pane comprises transparent material and is glued to the remaining part of the basin in water-tight manner.

21: Container according to claim 1, wherein the container is configured in the manner of a barrel having a round cross-section.

22: Container according to claim 17, wherein the container has a partial region that is configured without an outer wall and intermediate wall, and wherein the water-tight inner layer is formed by a round basin, which comprises transparent material, at least in the partial region.

23: Container according to claim 22, wherein only the partial region comprises transparent material, and wherein the partial region, in the form of a front pane, is glued to the remaining part of the round basin in water-tight manner.

24: Container according to claim 1, wherein the outer walls (20) are disposed in a metal frame (46).

25: Container according to claim 24, wherein multiple metal frames (46) disposed next to one another are provided for a side wall (18).

26: Container (48) for aquatic plants (14; 16), which can be filled with water (12), having side walls (50) and a bottom (52), wherein the side walls (50) and the bottom (52) are configured to be hollow and form a cavity (54), wherein a plant culture medium (56) that makes the growth of aquatic plants possible is provided on the bottom (52) of the container (48), and wherein winter-hardy (58) and/or non-winter-hardy aquatic plants (60) are disposed in the container (48), which is filled with water (12).

27: Container according to claim 26, wherein the cavity (54) is filled with an insulating material (62).

28: Container according to claim 27, wherein the insulating material (62) is water-repellent and comprises hydrophobic rock wool or polystyrene.

29: Container according to claim 26, wherein the winter-hardy aquatic plants (58) are formed by winter-hardy water lilies.

30: Container according to claim 26, wherein the cavity (54) is filled with air.

31: Container according to claim 26, wherein there is a vacuum in the cavity (54).

32: Container according to claim 26, wherein the inner sides of the side walls (50) and of the bottom (52) are covered with a water-tight film (64).

33: Container according to claim 26, wherein the inner sides of the side walls and the bottom are covered by a water-tight stable tub provided as an insert.

34: Container according to claim 26, wherein aquatic animals such as fish, amphibians, reptiles, snails or mollusks are situated in the water of the container.

35: Container according to claim 26, wherein the container (48) is provided with a protective grid (66) on its top, open side, through which the aquatic plants (58; 60) can grow.

36: Container according to claim 26, wherein the container (48) is provided with an overflow (70) to allow excess water (12) to flow off.
